(19) United States
(12) Patent Application Publication
(10) Pub. No.: US 2024/0201020 A1
(43) Pub. Date: Jun. 20, 2024

(54) COUPLING ELEMENT FOR A DEVICE FOR DETERMINING AND/OR MONITORING A PROCESS VARIABLE

(71) Applicant: Endress+Hauser Wetzer GmbH+Co. KG, Nesselwang (DE)

(72) Inventors: Pavo Vrdoljak, Nesselwang (DE); Torsten Iselt, Kempten (DE); Harald Bründl, Schwabhausen (DE); Marc Schalles, Erfurt (DE)

(21) Appl. No.: 18/554,832

(22) PCT Filed: Mar. 21, 2022
(86) PCT No.: PCT/EP2022/057322

§ 371 Date: Oct. 11, 2023

(30) Foreign Application Priority Data
Apr. 14, 2021 (DE) 10 2021 109 410.0

(51) Int. Cl. G01K 1/143; B33Y 80/00; F16M 13/02

(52) U.S. Cl. CPC G01K 1/143; F16M 13/02; B33Y 80/00

(57) ABSTRACT

A coupling element for a device for determining and/or monitoring a process variable, more particularly the temperature, the flow rate or the flow velocity, of a medium in a container includes a main body having a contact surface designed such that the main body can be applied to the container face to face via the contact surface, in which the main body includes a bore for receiving a sensor element of the device, which is configured for determining and/or monitoring the process variable, and a longitudinal axis of the bore runs tangentially to the contact surface.

The invention relates to a coupling element for a device for determining and/or monitoring a process variable, more particularly the temperature, the flow rate or the flow velocity, of a medium in a container, for fastening to the container, and to a corresponding device having a coupling element according to the invention. The container is, for example, a tank or a pipeline.

Although the coupling element according to the invention is also used for other types of field devices, the following description focuses on field devices in the form of thermometers, without limiting the generality. Thermometers are known from the prior art in a great variety of embodiments. Thus, there are thermometers which use the expansion of a liquid, a gas or a solid with a known coefficient of expansion in order to measure temperature, or also others which relate the electrical conductivity of a material, or a variable derived therefrom, to the temperature, such as electrical resistance when using resistance elements, or the thermoelectric effect in the case of thermocouples. On the other hand, radiation thermometers, in particular pyrometers, use the heat radiation of a substance to determine its temperature. The underlying measurement principles have each been described in a variety of publications.

In the case of a temperature sensor in the form of a resistance element, so-called thin-film and thick-film sensors and so-called thermistors (also referred to as NTC thermistors) have become known, among others. In the case of a thin-film sensor, in particular a resistance temperature detector (RTD), for example, a sensor element provided with connecting wires and mounted on a carrier substrate is used, the back side of the carrier substrate usually having a metal coating. As sensor elements, so-called resistance elements, for example, in the form of platinum elements, are used, which among other things are also commercially available under the designations PT10, PT100, and PT1000.

In the case of temperature sensors in the form of thermocouples, however, the temperature is determined by a thermovoltage which arises between the unilaterally connected thermo wires made of different materials. Thermocouples according to the DIN standard IEC584, e.g., thermocouples of type K, J, N, S, R, B, T, or E, are usually used as temperature sensors for temperature measurement. However, other pairs of materials, in particular those with a measurable Seebeck effect, are also possible.

The accuracy of the temperature measurement is highly dependent on the respective thermal contacts and the prevailing heat conduction. The heat flows between the medium, the container in which the medium is located, the thermometer and the process environment play a critical role here. For a reliable temperature determination, it is important that the respective temperature sensor and the medium are located substantially in thermal equilibrium, at least for a certain time required to measure the temperature. The time it takes a thermometer to respond to a temperature change is also referred to as the response time of the thermometer.

High measurement accuracy can be achieved in particular when the temperature sensor is immersed in the respective medium. Thus, numerous thermometers have become known in which the temperature sensor is more or less directly in contact with the respective medium. In this way, a relatively good coupling between the medium and the temperature sensor can be achieved.

However, non-invasive determination of the temperature is advantageous for various processes and for many containers, in particular small tanks or pipelines. For example, thermometers are also known that can be fastened from the outside/inside to the respective container in which the medium is located. Such devices, also referred to as surface thermometers or contact sensors, are known, for example, from documents such as DE102014118206A1 or DE102015113237A1.

In such measuring devices, the temperature sensors are not in direct contact with the respective process. This requires that various additional aspects be taken into account to ensure good thermal coupling. For example, the mechanical, and therefore thermal, contact between the tank and the thermometer is critical to the measurement accuracy that can be achieved. Accurate temperature determination is not possible in the case of insufficient contact.

Measuring inserts having temperature sensors in the form of thermocouples welded directly to the outer surface or skin of the pipe or tank are often used as surface or skin-point thermometers. In such cases, however, replacing thermocouples can be a time-consuming and costly process, in particular because replacement may require a temporary shutdown of the process and/or application. In order to overcome these disadvantages, embodiments of corresponding thermometers that allow simple replacement of temperature sensors have been disclosed, for example, in U.S. Pat. No. 5,382,093 or the previously unpublished European patent application with the file number 18198608.4.

Furthermore, numerous different embodiments of thermometers for non-invasive temperature measurement are known, as described for example in documents US2016/0047697A1, DE102005040699B3, EP3230704B1 or EP2038625B1.

A central problem in non-invasive temperature determination is the heat dissipation from the process to the environment. This results in a significantly higher measurement error than when the respective temperature sensor is inserted directly into the process.

The same problem also arises, for example, in the case of a flow meter based on the thermal measurement principle for determining a flow rate or a flow velocity of a medium in a pipeline. Such field devices typically comprise at least two sensor elements having at least one temperature sensor and at least one heating element or heatable temperature sensor. The sensor elements can be introduced into the respective pipeline and integrated into or onto a measuring tube (non-invasive design).

Based on the described problem of heat dissipation in the non-invasive temperature determination, the object of the invention is to provide a means by which the non-invasive determination of the temperature of a medium, in particular the measurement accuracy, can be improved.

This object is achieved by the coupling element according to claim 1 and by the device according to claim 12. Advantageous embodiments are the subject matter of the dependent claims.

With regard to the coupling element, the object of the invention is achieved by a coupling element for a device for determining and/or monitoring a process variable, more particularly the temperature, the flow rate or the flow velocity, of a medium in a container, for fastening to the container, which coupling element comprises a main body having a contact surface designed such that the main body can be applied to the container face to face by means of the contact surface, the main body having a bore for receiving a sensor element of the device for determining and/or monitoring the process variable, and a longitudinal axis of the bore running tangentially to the contact surface.

The coupling element is used for the targeted distribution of heat from the process to the sensor element and thus to improve the thermal contact or to ensure thermal equilibrium between the wall of the container and the sensor element.

The bore is designed to receive the sensor element, in particular a temperature sensor, which is preferably arranged in a measuring insert. The sensor element, which can be inserted into the bore, is accordingly arranged or aligned relative to the container by means of the coupling element. In the following, the tangential course of the bore relative to the contact surface is understood to mean various possible arrangements that have in common the fact that a longitudinal axis extends through the bore in a plane parallel to a tangent to the typically curved wall of the container. A distance between an, in particular imaginary, contact point of the tangent and the longitudinal axis of the bore or an angle between the tangent and the longitudinal axis of the bore may be different depending on the embodiment. Furthermore, numerous further variants which also fall within the scope of the present invention are conceivable for the design of the coupling element, in particular of the sensor element that can be inserted into the bore relative to the wall of the container.

The process variable, in particular the temperature, the flow rate or the flow velocity, of the medium is therefore determined indirectly via a wall of the container. A contact surface between the sensor element and a portion of the wall of the container facing the sensor element is significantly enlarged by the coupling element, in particular by arranging the bore relative to the contact surface or relative to the wall of the container. In this way, the heat conduction from the medium via the wall of the container to the sensor element and, if present, to connecting lines contacting the sensor element is significantly increased. In addition, a temperature gradient is reduced. All of these effects, in turn, result in an improvement in the measurement accuracy.

Preventing heat dissipation errors is in particular a fundamental problem in the field of industrial temperature determination, irrespective of whether a thermometer or a flow meter is used in each case. In the case of invasive thermometers, in this context, the minimum immersion depth in the respective process is often relevant, which should usually be at least ten times the thermometer diameter. If thermal contact is compromised, for example, by the use of a protection tube, the minimum immersion depth should even be more than ten times the thermometer diameter. In the case of block calibrators, the minimum immersion depth is usually fifteen times the diameter of the reference thermometer used for calibration. However, in the case of a non-invasive temperature determination, as in the case of the present invention, other measures must be taken to ensure homogeneous temperature control of the respective sensor element. However, due to the highly inhomogeneous heat input in such a measurement, this is significantly more complex than in the case of an invasive temperature determination. The use of a coupling element according to the invention is a particularly effective measure in this context.

In the context of the present invention, on the one hand, it is conceivable to introduce the sensor element directly into the bore. However, it is also conceivable that the sensor element is part of an, in particular, elongated measuring insert that can be inserted into the bore. The coupling element can have a bore or a plurality of bores into which one or more sensor elements can be introduced. It is also conceivable to introduce a plurality of sensor elements into the same bore. Furthermore, a unit for heating and/or cooling a region surrounding the sensor element can also be introduced into a bore, together or separately from a sensor element.

The device can optionally also have an electronics module. Alternatively, the electronics module can also be a separate component that can be connected to the device. In addition, the coupling element can be fastened to the container by means of any suitable fastening means that are customary to a person skilled in the art, such as clamps or pipe sleeves.

In contrast to various solutions known from the prior art, in which the measuring insert is placed on the tank, for example, perpendicularly to a longitudinal axis of the container, and accordingly comes into thermal contact via the end face, in the case of the present invention the measuring insert is guided tangentially past a wall of the container by means of the coupling element. Accordingly, the thermal contact between the sensor element and the wall of the container takes place via a lateral surface of the measuring insert. Such an arrangement offers various advantages: firstly, a relatively compact or space-saving design can be achieved. In addition, the coupling element according to the invention results in significantly improved heat conduction between the medium and the sensor element, and thus in a significantly improved measuring accuracy with respect to the determination of the process variable, in particular the temperature of the medium or a variable related to the temperature, such as the flow rate or the flow velocity. This is achieved by minimizing the distance between the wall of the container and the sensor element in the solution according to the invention by means of the coupling element in the region of a lateral surface of the sensor element. By suitably designing the coupling element or arranging the bore in the main body relative to the contact surface, the distance can be minimized particularly easily, which results in improved heat conduction. It is advantageously possible to achieve a distance that is significantly smaller than a corresponding distance in other arrangements of the sensor element relative to the container. In addition, by means of the coupling element according to the invention, planar contacting with the wall of the container can be achieved, which also increases the heat conduction from the medium to the sensor element and thus improves the measurement accuracy.

In one embodiment, the device comprises at least one reference element for in situ calibration and/or validation of at least the temperature sensor that is fastened to the outer wall of the container, which reference element consists at least in part of at least one material, for which material, in the temperature range relevant to the calibration of the first temperature sensor, there is at least one phase transition at least one predetermined phase transition temperature, for which phase transition the material remains in the solid phase. In this regard, reference is made to EP02612122B1, to which reference is made in its entirety within the scope of the present patent application.

In a further embodiment, the contact surface is designed to correspond to a surface. In this way, a precisely fitting arrangement of the coupling element relative to the wall of the container can be achieved. Typical containers, i.e., tanks or pipelines, have curved surfaces. For example, in the case of a convex surface of a wall of the container, a concave contact surface of the coupling element is advantageous.

In another embodiment, the contact surface consists at least in part of a deformable, in particular, flexible or ductile, material, which is designed such that it can be adapted to a contour of the outer wall of the container. The contact surface can accordingly be adapted to the surface of the wall of the container. This has the advantage that the coupling element can compensate for small nominal width differences, shape deviations and/or unevenness of the surface of the respective wall of the container.

In one embodiment of the coupling element, the bore is closed in an end region, which end region lies in particular within a volume of the main body. Accordingly, the bore is a blind hole into which the sensor element can be introduced.

In a further embodiment, the coupling element comprises a shaft that projects from the main body and opens into the bore. The shaft is arranged parallel to the bore and in one plane with the bore. It is preferably a tubular, in particular cylindrical, element for receiving the measuring insert. The shaft can be attached to the main body or produced in one piece with the main body. In addition to improved mechanical stability and thermal insulation with respect to the environment of the device, the shaft serves to improve heat conduction or heat transfer from the process to the measuring insert. In particular, a shaft can be used to enlarge a region around the measuring insert in which a substantially homogeneous temperature distribution can be achieved.

It is advantageous if the coupling element is designed and/or arranged such that a longitudinal axis of the container, in particular of a pipeline, and a longitudinal axis of the bore are arranged at a predeterminable angle, in particular perpendicular to one another. An angled arrangement of the bore relative to the longitudinal axis of the container allows for particularly easy handling or a simple way of installing and removing the sensor element in and from the bore, respectively.

In one embodiment, the coupling element comprises a pipeline portion arranged adjacent to the contact surface, which pipeline portion is used to guide the medium. In this case, the pipeline portion and the coupling element can subsequently be connected to one another or be manufactured in one piece from the outset. In this case, it is in principle a coupling element in the form of a T-piece for a pipeline.

In a further embodiment, in the region of the contact surface, a unit comprising at least in part a material having anisotropic thermal conductivity, preferably an at least partially carbon-containing material, in particular graphite or hexagonal boron nitride, is arranged, or the main body consisting of the material having anisotropic thermal conductivity in a region facing the contact surface or in the region of the contact surface. In this context, reference is made to the German patent application with the reference number DE102017100267A1, to which reference is made in full within the scope of the present invention.

In one embodiment of the coupling element, thermal insulation made of a thermally insulating material is arranged in a region of the main body facing away from the contact surface and the bore, which thermal insulation at least partially surrounds the main body, or the main body consists of the thermally insulating material in said region. This embodiment accordingly includes thermal insulation with respect to an environment of the coupling element and the container.

In a further embodiment of the coupling element, the main body consists of a thermally conductive material in a region facing the contact surface and the bore. This measure serves to further improve heat conduction from the medium or from the wall of the container to the sensor element.

In one embodiment of the coupling element, the main body is constructed from at least two components, in particular in the form of a layered structure. It is therefore a multi-component or multi-layer structure.

In a further embodiment, the main body is produced at least in part from a sintered material or a composite material. In the case of a sintered material, it is also advantageous if the sintered material or composite material contains, at least in a partial region, a material having anisotropic thermal conductivity, in particular a material containing carbon, for example graphite.

It is also conceivable that the unit that comprises the material having the anisotropic thermal conductivity is attached, in particular sintered, to the main body. In particular, the main body can also be a sintered body consisting of two or more layers.

It is also conceivable to produce the main body from a sintered material into which an additional, second material is introduced at least in part, in particular completely. In particular, this additional material can be introduced at least in part into the pores of the sintered material. This material can be, for example, graphite, it being possible to use the graphite, in addition to or as an alternative to the above-mentioned function of the targeted heat conduction, for example as a solid lubricant, which solid lubricant can reduce a contact resistance between the main body and the container or the main body and the measuring insert. It should be pointed out that, in addition to graphite, other materials are also considered and also fall within the scope of the present invention, in particular also as solid lubricants.

It is advantageous if the coupling element is designed in one piece and is produced, in particular, by means of a generative manufacturing process, preferably by means of a 3D printing process. Alternatively, it is conceivable that the coupling element has at least two, in particular separately manufactured, coupling components.

In a further embodiment, the coupling element finally comprises fastening means for fastening the main body to the container. The fastening means are preferably at least in part an integral component of the coupling element. For example, the fastening means can be means for producing a clamping screw connection, a screw connection, a spring connection or the like.

In summary, numerous different embodiments are conceivable for the coupling element according to the invention, in which the at least one bore runs tangentially to the contact surface or to the wall of the container on which the contact surface rests in the state fastened to the container. Some particularly preferred variants have been explicitly described above. However, the possible embodiments of the coupling element are by no means limited to the variants explicitly mentioned above. Thus, for example, a shell-like configuration of the main body or an at least partially hollow main body is conceivable. The present invention also includes design freedom with respect to the size of the coupling element relative to the diameter of the container. The coupling element can be both a relatively large-volume component and have a compact, in particular, shaft-shaped or shell-shaped form. The coupling element, in particular the main body, can also be designed both in one piece and in multiple parts.

An advantage of the coupling element according to the invention is that no modifications to the field device itself are required to implement a non-invasive arrangement of a field device. For example, in the case of a field device in the form of a thermometer, a typical thermometer measuring insert can be used and introduced into the bore of the coupling element.

The object of the invention is further achieved by a device for determining and/or monitoring a process variable, in particular the temperature, the flow rate or the flow velocity, of a medium in a container, comprising a sensor element and a coupling element according to at least one of the preceding claims.

The sensor element is preferably a temperature sensor, in particular in the form of a resistive element or a thermocouple. The sensor element typically also has connection lines that can likewise be introduced at least in part into the bore of the coupling element. The sensor element and the at least one connecting line are, for example, part of a measuring insert, in particular a jacket element, which is introduced into the bore of the main body of the coupling element.

In addition to devices in the form of thermometers, flow meters also come into consideration for the present invention. In this case, the device preferably also comprises a heating element that can be fastened to the outer wall of the container, in particular by means of the coupling element. The sensor element and a region surrounding the sensor element can be heated to a predeterminable temperature by means of the heating unit. In the context of the present invention, the term “flow” includes both a volume flow and a mass flow of the medium. Likewise, a flow rate or flow velocity of the medium can be determined.

For example, the flow can be determined in two different ways. According to a first measurement principle, a sensor element is heated such that its temperature remains substantially constant. In known, and at least temporarily constant medium properties, such as the medium temperature, its density or also composition, the mass flow of the medium through the pipeline can be determined on the basis of the heating power required to maintain the temperature at a constant value. In this case, the medium temperature means the temperature of the medium without any additional heat input from a heating element. In contrast, in the second measurement principle, the heating element is operated at a constant heating power and the temperature of the medium downstream of the heating element is measured. In this case, the measured temperature of the medium gives information about the mass flow. In addition, however, other measurement principles have also become known, such as transient methods, in which the heating power or the temperature is modulated.

For example, the heating element can be designed in the form of a resistive heater that is heated via the conversion of electrical power supplied to it, for example as a result of an increased supply of power.

The invention will be explained in more detail with reference to the following figures. In the figures:

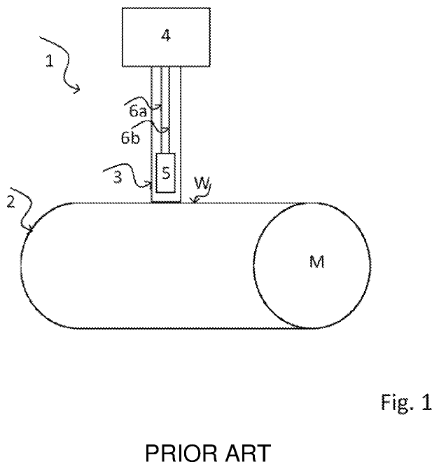

FIG. 1 shows a thermometer for non-invasive temperature measurement according to the prior art;

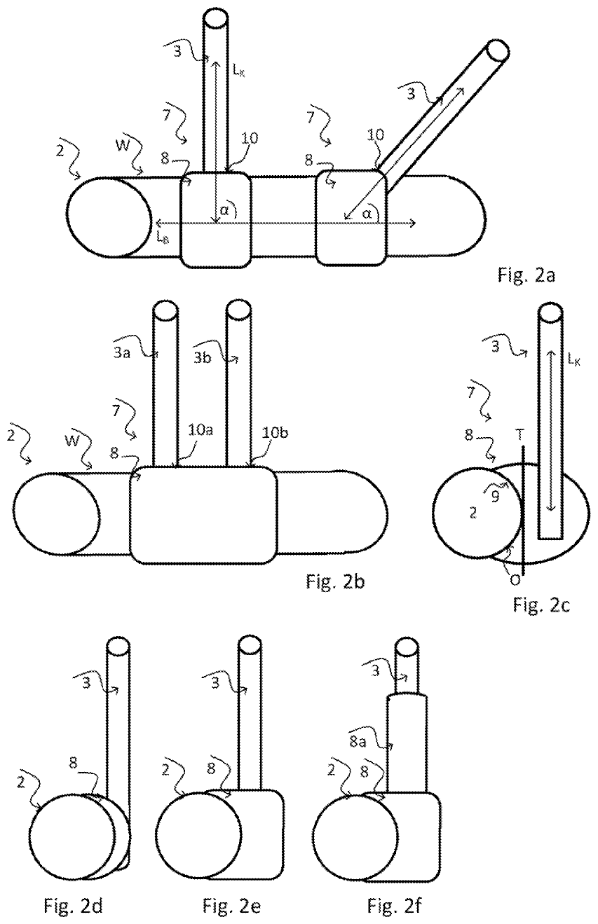

FIG. 2 shows possible embodiments of a coupling element according to the invention, which is shown schematically fastened to a pipeline;

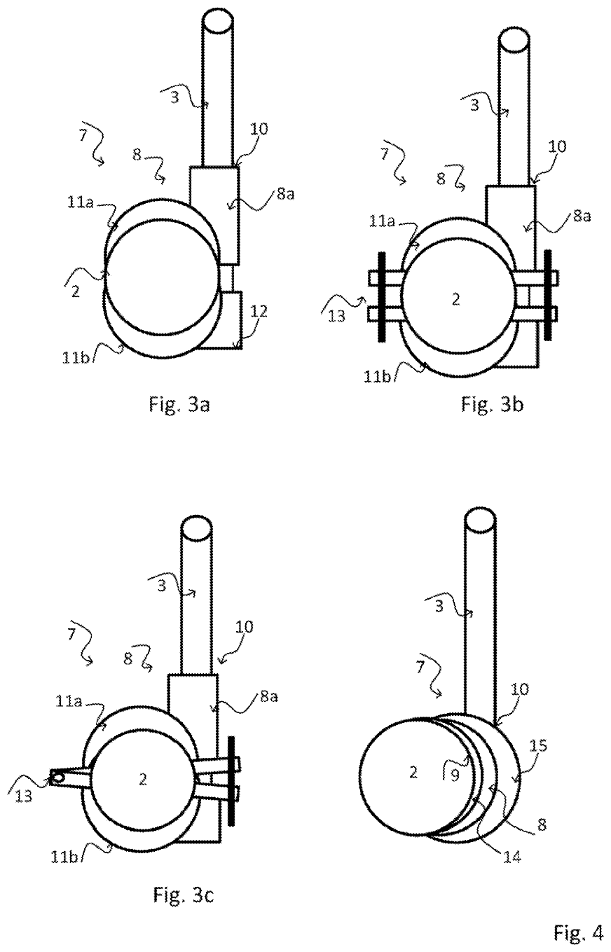

FIG. 3 shows possible embodiments of a multi-part coupling element according to the invention and possible fastening means for fastening the coupling element to a container in the form of a pipeline;

FIG. 4 shows a possible embodiment of a coupling element according to the invention with thermal insulation;

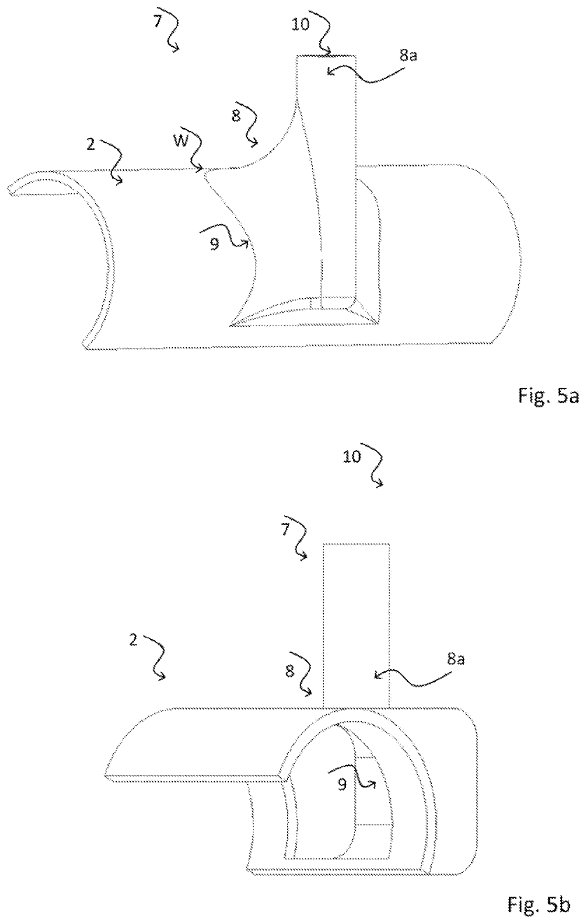

FIG. 5 shows a first possible embodiment of a coupling element produced in one piece; and

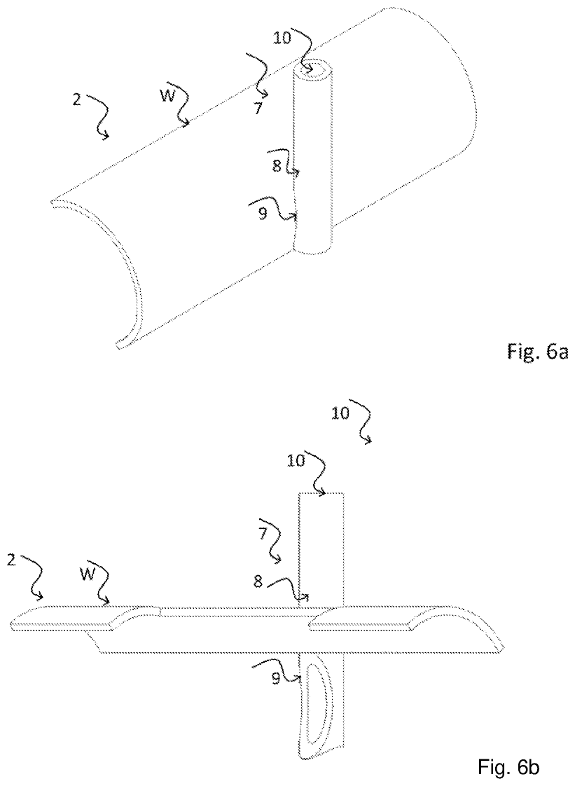

FIG. 6 shows a second possible embodiment of a coupling element produced in one piece.

In the figures, identical elements are respectively provided with the same reference signs. The embodiments from the various figures can also be combined with one another as desired. In addition, all figures relate to containers in the form of pipelines and field devices in the form of thermometers. However, the present invention is in no way limited to pipelines or thermometers. Rather, the respective considerations can be readily applied to other types of containers and field devices.

FIG. 1 is a schematic representation of a thermometer 1 according to the prior art with a measuring insert 3 and an electronics module 4. The thermometer 1 is used to detect the temperature T of a medium M located in a container 2, in this case in the form of a pipeline. For this purpose, the thermometer 1 does not project into the pipeline 2, but rather is placed on a wall W of the pipeline 2 from the outside for non-invasive temperature determination.

The measuring insert 3 comprises a sensor element in the form of a temperature sensor 5, which in the present case comprises a temperature-sensitive element in the form of a resistive element. The temperature sensor 5 is electrically contacted via the connection lines 6a, 6b and connected to the electronics module 4. While the thermometer 1 shown has a compact design having an integrated electronics module 4, the electronics module 4 can also be arranged separately from the measuring insert 3 in other thermometers 1. In addition, the temperature sensor 5 need not necessarily be a resistive element, nor does the number of connection lines 6 used need necessarily be two. Rather, the number of connection lines 6 can be selected appropriately depending on the measurement principle used and the temperature sensor 5 used.

As already explained, the measuring accuracy of such a thermometer 1 depends to a large extent on the respective materials used for the thermometer and on the respective contacting means, in particular thermal contacting means, in particular in the region of the temperature sensor 5. The temperature sensor 5 is in thermal contact with the medium M indirectly, i.e., via the measuring insert 3 and the wall W of the container 2. Heat dissipation from the medium M to the environment also plays a major role in this context, which can lead to an undesired temperature gradient in the region of the temperature sensor 5.

In order to suitably counteract these problems, an alternative embodiment for non-invasive determination of a process variable, for example by means of the thermometer 1, is proposed within the scope of the present invention, as shown in FIGS. 2 to 6 by way of some preferred exemplary embodiments.

The invention is based on the use of a coupling element 7, as shown for example in FIG. 2. As illustrated in FIG. 2c, the coupling element 7 has a main body 8 having a contact surface 9 by means of which the main body 8 can be applied to the container 2, in particular to the wall W of the container 2, face to face and in particular with a precise fit. The contact surface 9 is preferably designed to correspond to a surface O of the wall W of the container 2. The main body 8 also has a bore 10 into which the sensor element 5 of the device 1 can be introduced, for example, the measuring insert 3 having the sensor element 5 and the connection lines 6a and 6b of FIG. 1. According to the invention, a longitudinal axis L_{K} of the bore 10 is tangential to the contact surface 9 of the coupling element 7, i.e., in a plane parallel to a tangent T to the contact surface 9 or to the wall W of the container 2.

FIG. 2a shows a first embodiment of a coupling element 7 according to the invention, in which an angle α between the longitudinal axis L_{K} of the bore 10 and a longitudinal axis L_{B} of the pipeline 2 6 is α=90° in the coupling element 7 shown on the left, i.e., it is perpendicular to the longitudinal axis L_{B} of the pipeline 2. In contrast, in the case of the coupling element 7 shown on the right, α=45°. It is also conceivable for the coupling element 2 to have bores 10a and 10b, each of which is used to receive a measuring insert 3a and 3b, as illustrated in FIG. 2b. In the case of a plurality of bores 10a and 10b, the respective angles α can be the same, as in the case of FIG. 2b, or at least partially different.

Numerous different variants are also conceivable for the design of the main body 8, as illustrated for example in FIG. 2d to FIG. 2f. In the embodiment according to FIG. 2d, the main body 8 is shell-shaped in order to allow for a compact design. The embodiment according to FIG. 2e is a large-volume main body 8 that can bring advantages in particular with regard to thermal insulation with respect to an environment of the coupling element 7 and the measuring insert 3. In addition, such an embodiment is typically more mechanically robust. In the embodiment according to FIG. 2f, the main body 8, which is designed similarly to the case of FIG. 2e, additionally comprises a shaft 8a for receiving the measuring insert 3. The shaft 8a has various functions, in particular, it is used to improve heat conduction from the wall W of the container 2 to the measuring insert 3 and to enlarge a region having homogeneous temperature distribution around the measuring insert 3. In addition, the shaft 8a can be used to improve the thermal insulation and/or the mechanical stability of the device 1 or of the measuring insert 3 in the bore 10 of the main body 8.

FIG. 3 shows various possible embodiments of multi-part coupling elements 7 and of possible fastening means 13. In the case of FIG. 3a, the main body 8 is designed in two parts and with a shaft 8a and has two coupling components in the form of half shells 11a and 11b, which can be arranged around the pipeline 2. The bore 10 runs in the region of both half shells 11a and 11b and is closed in an end region 12. It should be pointed out that, in other embodiments, the main body 8 can also have more than two coupling components, and that, even in the case of two coupling components, these do not necessarily have to be designed in the form of half shells 11a and 11b. Rather, numerous different variants are conceivable, all of which fall under the present invention.

Various variants are also conceivable for fastening the coupling components, here the two half shells 11a and 11b, to one another and for fastening the main body 8 to the container 2. In the case of the embodiment shown in FIG. 3b, the coupling element 7 comprises fastening means 13 for producing a screw connection by means of two screws that are used simultaneously to fasten the two half shells 11a and 11b to one another and to the pipeline 2. In contrast, in the case of the embodiment shown in FIG. 3c, fastening means 13 are provided that comprise a hinge and a screw. Other embodiments can comprise other fastening means 13, for example those with connecting elements, clamps, tensioners, straps or springs. In this case, the fastening means 13 can be used both for fastening a plurality of components of the main body 8 to one another and for fastening the coupling element 7 to the pipeline 2. However, separate fastening means 13 can also be used for these two purposes. In the case of a one-piece coupling element 7, only one fastening to the container 2 is required.

FIG. 4 shows a coupling element 7 having a unit 14 comprising a material having anisotropic thermal conductivity and thermal insulation 15. The unit 14 is arranged in a region of the main body 8 facing the container 2, while the thermal insulation 15 is arranged in a region of the main body facing away from the container 2 and is used for insulation with respect to the environment of the coupling element or the device 1.

A first possible embodiment of an integrally produced coupling element 7 is illustrated in FIG. 5. The coupling element 7 has a main body 8 having an (optional) shaft 8a and a bore 10 for receiving a measuring insert 3 having a sensor element 5. The contact surface 9 rests flat against the wall W of the container 2. The surface of the contact surface 9 is as large as possible, in particular maximally, while an extension of the main body 8 perpendicular to the contact surface 9 is particularly small, in particular minimally. This results in a particularly compact design. In addition, such an embodiment also ensures reduced, in particular minimized, heat loss to the environment. This effect can be further increased by suitable measures with respect to the design or the structure of the main body 8, for example with respect to internal heat conduction, in particular the main body 8 can be designed such that increased heat conduction takes place from the contact surface 9 to the bore 10 or to the shaft 8a.

While the main body 8 is a solid body in the case of FIG. 5a, the main body 8 shown in FIG. 5b is a hollow body. A main body 8 in the form of a hollow body offers the additional advantage that the measuring insert 3 comes into direct contact with the wall W of the container 2. This reduces the distance between the sensor element 5, which is arranged in the measuring insert 3, and the wall W of the container 2, to which the measuring insert 3 is arranged tangentially, which in turn results in a further improvement of the heat conduction from the medium M to the sensor element 5.

Finally, FIG. 6 shows a shaft-like embodiment of the main body 8 of the coupling element 7. This embodiment constitutes a particularly compact and simple design. It is also conceivable for this embodiment to use a solid (FIG. 6a) main body 8 and a main body in the form of a hollow body (FIG. 6b). In addition to the two variants for a one-piece main body 8 from FIGS. 5 and 6, numerous further possible embodiments for a main body 8 of a coupling element 7 according to the invention which also fall within the scope of the present invention are conceivable. In particular, the embodiments shown in FIGS. 5 and 6 can also be combined with one another as desired. In summary, it is an advantage of the present invention that a standard measuring insert 3, for example a thermometer 1, can be used to realize a non-invasive thermometer 1. For this purpose, the coupling element 7 according to the invention has a bore 10 for receiving the measuring insert 3. Adaptation to the geometry of the container 2 is effected by means of the contact surface 9 of the coupling element 7. In contrast to other solutions known from the prior art, a longitudinal axis L of the measuring insert 3 runs tangentially to the wall of the container W, whereby improved heat conduction can be achieved.

### LIST OF REFERENCE SIGNS

1 Device
2 Container
3 Measuring insert
4 Electronics module
5 Temperature sensor
6 Connecting wires
7 Coupling element
8 Main body
9 Contact surface
10 Bore
11 a, b Coupling components, in the form of half shells
12 End region
13 Fastening means
14 Unit having anisotropic thermal conductivity
15 Thermal insulation
M Medium
T Temperature
W Wall of the container
L_{B} Longitudinal axis of the container
L_{K} Longitudinal axis of the coupling element
α Angle between the longitudinal axes
T Tangent

1-15. (canceled)

16. A coupling element for fastening a device to a container, the device configured for determining and/or monitoring a process variable, including the temperature, the flow rate or the flow velocity, of a medium in the container, the coupling element comprising:
a main body including a contact surface configured to enable the main body to be applied to the container face to face via the contact surface,
wherein the main body includes a bore configured to receive a sensor element of the device, the sensor element configured for determining and/or monitoring the process variable, and
wherein a longitudinal axis of the bore extends tangentially to the contact surface.

17. The coupling element according to claim 16, wherein the contact surface is adapted to correspond to a surface of the container.

18. The coupling element according to claim 16, wherein the contact surface comprises, at least in part, a deformable, flexible or ductile material, which is selected and configured such that the contact surface can be adapted to a contour of an outer wall of the container.

19. The coupling element according to claim 16, wherein the bore is closed in an end region, which end region lies within a volume of the main body.

20. The coupling element according to claim 16, further comprising a shaft that extends from the main body and opens into the bore.

21. The coupling element according to claim 16, wherein the coupling element is configured and/or arranged such that a longitudinal axis of the container and the longitudinal axis of the bore are arranged at a predeterminable angle.

22. The coupling element according to claim 21, wherein the longitudinal axis of the container and the longitudinal axis of the bore are arranged perpendicular to each other.

23. The coupling element according to claim 16, wherein the container is a pipeline conveying the medium.

24. The coupling element according to claim 16, further comprising a pipeline portion arranged adjacent the contact surface, which pipeline portion is configured to guide the medium.

25. The coupling element according to claim 16, wherein, in a region of the contact surface, a member comprising a material having anisotropic thermal conductivity is arranged, or
wherein the main body consists of the material having anisotropic thermal conductivity in a region facing the contact surface.

26. The coupling element according to claim 25, wherein the material having anisotropic thermal conductivity comprises graphite or hexagonal boron nitride.

27. The coupling element according to claim 16, wherein thermal insulation comprising a thermally insulating material is arranged in a region of the main body facing away from the contact surface and the bore, which thermal insulation at least partially surrounds the main body, or
wherein the main body consists of the thermally insulating material in the region of the main body facing away from the contact surface and the bore.

28. The coupling element according to claim 16, wherein the main body consists of a thermally conductive material in a region facing the contact surface and the bore.

29. The coupling element according to claim 16, wherein the main body is constructed from at least two components in a layered structure.

30. The coupling element according to claim 16, wherein the main body is fabricated, at least in part, from a sintered material or a composite material.

31. The coupling element according to claim 16, wherein the coupling element is embodied in one piece and is fabricated by a generative manufacturing process, or wherein the coupling element includes at least two, separately manufactured, coupling components.

32. The coupling element according to claim 16, wherein the generative manufacturing process is a 3D printing process.

33. The coupling element according to claim 16, further comprising a fastener configured to fasten the main body to the container.

34. A device for determining and/or monitoring a process variable, including a temperature, a flow rate or a flow velocity, of a medium in a container, the device comprising:
a sensor element; and
the coupling element according to claim 16.
